(19) United States
(12) Patent Application Publication
(10) Pub. No.: US 2015/0028598 A1
(43) Pub. Date: Jan. 29, 2015

(54) MAGNETIC POWER GENERATION

(71) Applicant: Yaacov Kolcheh, Yavne (IL)

(72) Inventor: Yaacov Kolcheh, Yavne (IL)

(21) Appl. No.: 14/360,662

(22) PCT Filed: Dec. 1, 2011
(86) PCT No.: PCT/IL11/00918

§ 371 Date: Aug. 3, 2014

(51) Int. Cl. H02K 1/34; H02K 7/18

(52) U.S. Cl. CPC H02K 1/34; H02K 7/1853; Y10S 74/09; H02K 53/00
USPC 290/1 R; 310/152; 74/DIG. 9

(57) ABSTRACT

A magnetic power generating machine, including a central magnet, which is configured to traverse a path having first and second ends, and is connected by a linkage to rotate a shaft as the central magnet traverses the path, first and second side magnets, which are respectively disposed adjacent to the first and second ends of the path and are oriented to repel the central magnet, so that a magnetic force between the central magnet and the first and second side magnets causes the central magnet to oscillate between the ends of the path, thereby rotating the shaft and first and second shutter assemblies, each including at least one ferromagnetic shutter and a mechanism which is arranged to open the at least one ferromagnetic shutter as the central magnet approaches the shutter assembly, thereby modulating the magnetic force synchronously with oscillation of the central magnet.

### FIELD OF THE INVENTION

The present invention relates generally to power generation, and specifically to the use of permanent magnets in generating mechanical or electrical power.

### BACKGROUND AND SUMMARY OF THE INVENTION

Permanent magnets are widely used in electric power generators, typically based on electromagnetic induction. Operation of these generators requires that shaft motion be provided by an external power source, such as an internal combustion engine or turbine.

In contrast to these prior art devices, an embodiment of the present invention provides a machine that converts magnetic force into motion. The machine comprises a central magnet, which is configured to traverse a path between two side magnets and is connected by a linkage to rotate a shaft. The side magnets are oriented to repel the central magnet. Thus, a magnetic force between the central magnet and the side magnets causes the central magnet to oscillate between the ends of the path, thereby rotating the shaft. Shutter assemblies are disposed between the side magnets and the respective ends of the path. Each shutter assembly comprises at least one ferromagnetic shutter and a mechanism, which opens the ferromagnetic shutter as the central magnet approaches the shutter assembly, thereby modulating the magnetic force synchronously with oscillation of the central magnet.

### BRIEF DESCRIPTION OF THE DRAWINGS

The present invention will be more fully understood from the following detailed description of the embodiments thereof, taken together with the drawings in which:

FIG. 1A is a schematic, pictorial illustration of a machine for magnetic power generation, in accordance with an embodiment of the present invention;

FIGS. 1B and 1C are schematic frontal and top views, respectively, of the machine of FIG. 1A;

FIGS. 2A and 2B are schematic, pictorial illustrations showing motion of a central magnet between first and second ends of a motion path in the machine of FIG. 1A, in accordance with an embodiment of the present invention;

FIGS. 3A and 3B are schematic frontal views of the machine of FIG. 1A showing the motion of the central magnet between the first and second ends of the motion path;

FIGS. 4A and 4B are schematic top views of the machine of FIG. 1A showing the motion of the central magnet between the first and second ends of the motion path; and

FIG. 5 is a schematic frontal view of a machine for magnetic power generation, in accordance with another embodiment of the present invention.

### DETAILED DESCRIPTION OF EMBODIMENTS

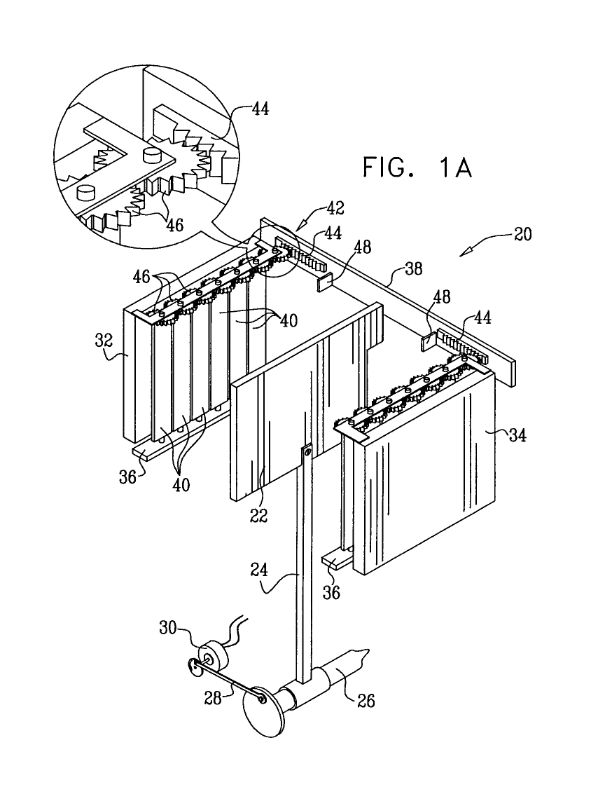

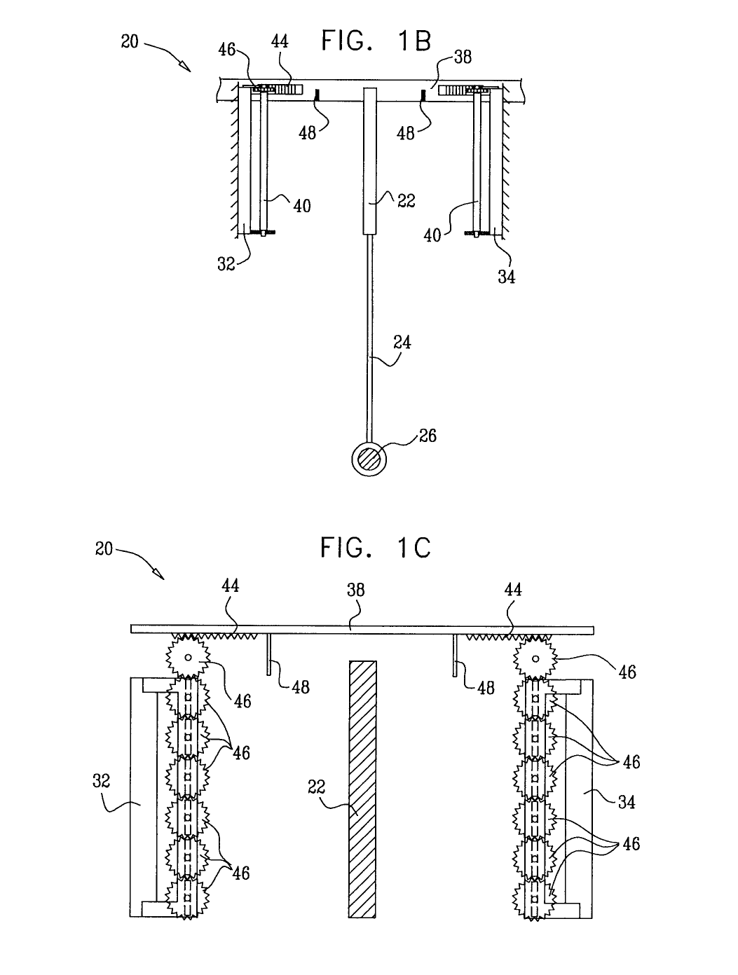

Reference is now made to FIGS. 1A, 1B and 1C, which schematically illustrate a machine for magnetic power generation, in accordance with an embodiment of the present invention. FIG. 1A is a pictorial view of the machine, while FIGS. 1B and 1C show frontal and top views, respectively.

Machine 20 comprises a central magnet 22, which is connected by a linkage 24 to a shaft 26. The central magnet is mounted so as to be able to traverse a path whose ends are bounded by stops 48. As the central magnet traverses this path, it turns shaft 26 alternately clockwise and counterclockwise. In this embodiment, shaft 26 is connected by a transmission 28 to turn an electric power generator 30, thereby generating an electrical current. Alternatively, shaft 26 may be coupled to mechanisms of other sorts for generating electrical power or performing other mechanical work, as will be apparent to those skilled in the art.

Side magnets 32 and 34 are disposed adjacent to opposite ends of the path of central magnet 22. The side magnets are oriented so as to repel the central magnet. Although magnets 22, 32 and 34 are shown in the figures, by way of example, as having planar shapes, the magnets may alternatively be made in any shape suitable for the purposes described herein. Brackets and connectors that may be used to hold and guide the magnets are omitted from the figures for the sake of simplicity.

Shutter assemblies 36 are respectively disposed between side magnets 32 and 34 the adjacent ends of the path of central magnet 22. Each shutter assembly comprises a row of ferromagnetic shutters 40, which are configured to open and close under the control of a shutter mechanism 42. In the present embodiment, this mechanism comprises a rack 44, mounted on a frame 38, together with a set of pinion gears 46. Each shutter 40 is attached to a respective gear 46, so that the shutters open and close as the respective gears turn, as described hereinbelow. Alternatively, other sorts of mechanisms can be used to open and close the shutters, as will be apparent to those skilled in the art. When shutters 40 are closed, they serve to shield central magnet 22 from the direct magnetic fields of side magnets 32 and 34. For this purpose, the shutters may comprise, for example, solid sheets of suitable steel or other ferromagnetic material, or alternatively laminates or other combinations of ferromagnetic and other materials.

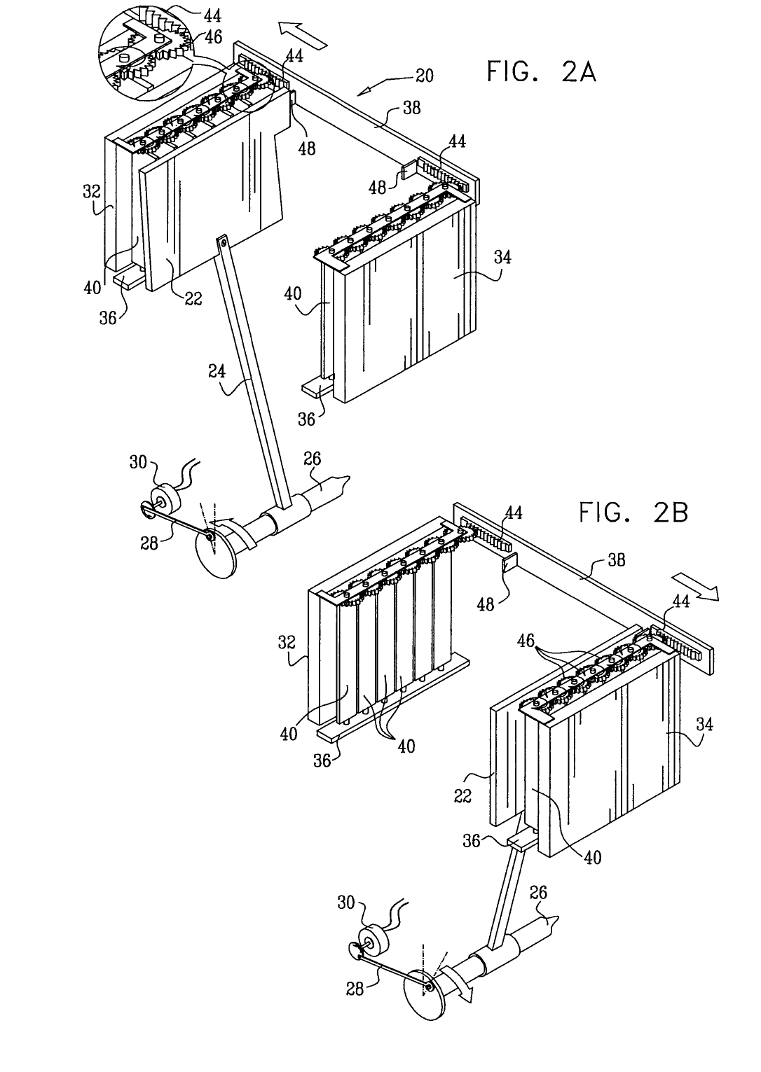

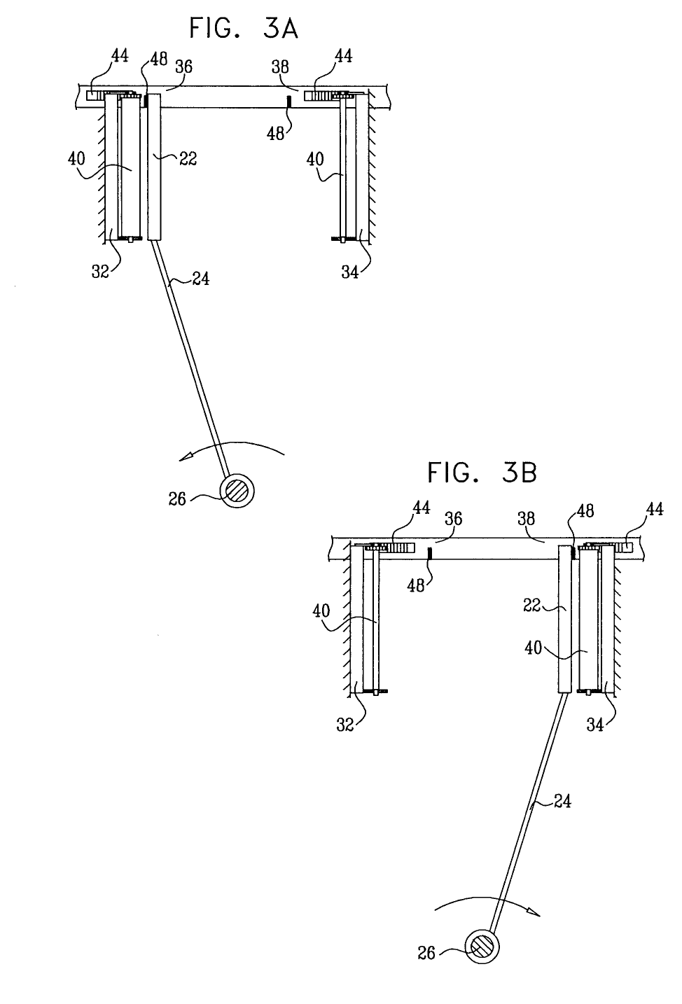

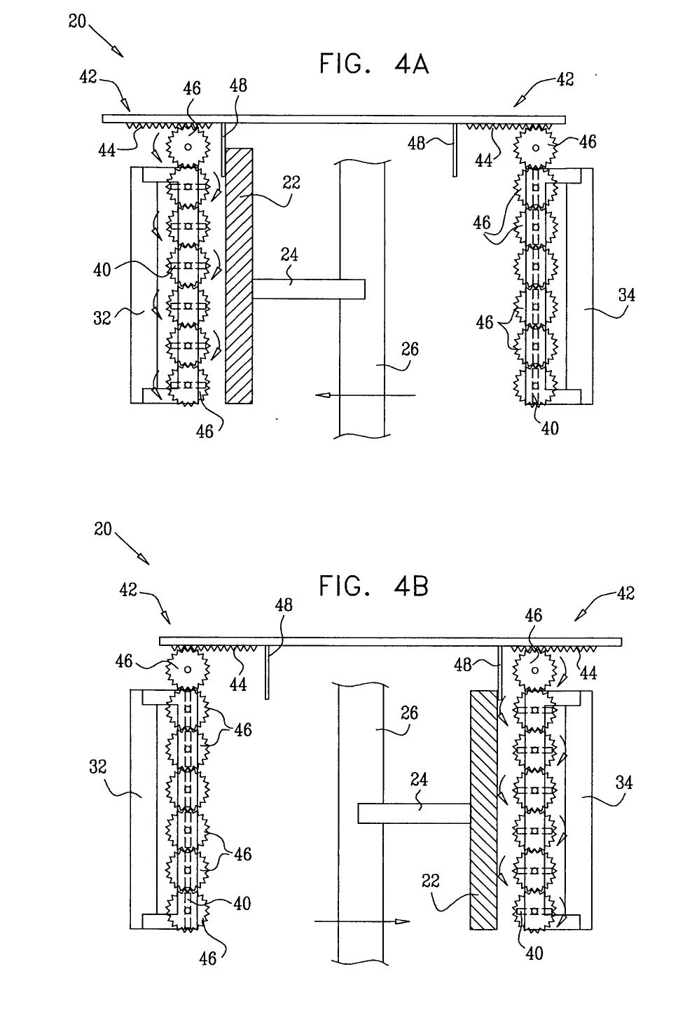

Reference is now made to FIGS. 2A, 2B, 3A, 3B, 4A and 4B, which schematically illustrate motion of central magnet 22 between the ends of its motion path in machine 20, in pictorial, frontal, and top views, respectively in accordance with an embodiment of the present invention. In these figures, central magnet 22 is assumed to be connected to linkage 24 by a suitable hinged mounting (not shown in the figures) so that the central magnet remains parallel to the planes of side magnets 32 and 34. Alternatively, the central magnet may be mounted in a fixed orientation relative to linkage 24. In this latter case, the side magnets may optionally be inclined so that they are roughly parallel to the planes of the central magnet at the respective ends of the path.

To initiate operation of machine 20, central magnet 22 is moved to one end of its path, such as the left end, as shown in FIGS. 2A, 3A and 4A. Moving the central magnet to the left causes shutter assembly 36 that is adjacent to side magnet 32 to move to the right, toward the central magnet. This movement may be engendered by magnetic attraction between the central magnet and the ferromagnetic material in shutters 40. Alternatively or additionally, other means (not shown in the figures) may be provided to cause the shutter assembly to move toward the central magnet. For example, there may be additional magnets on the shutter assembly that are oriented so as to attract the central magnet, or there may be a mechanical linkage between the central magnet and the shutter assembly. Side magnet 32 may be mounted to move toward the central magnet together with its respective shutter assembly, as shown in the figures, or the side magnet may alternatively remain fixed in place while the shutter assembly moves away from it toward the central magnet.

In any case, the movement of shutter assembly 36 toward central magnet 22 causes pinion gear 46 in shutter mechanism 42 to rotate on rack 44, thereby turning shutters 40 to open. When the shutters are open, their previous magnetic shielding effect is diminished. The repulsive force exerted by side magnet 32 now causes central magnet 22 to reverse direction and move away toward the opposite end of its path. The repulsive force (or other linkage) similarly causes shutter assembly 36 to move back, away from the central magnet, whereby mechanism 42 closes the shutters.

Central magnet 22 now moves toward the right end of its path, as shown in FIGS. 2B, 3B and 4B. As the central magnet approaches side magnet 34, the adjacent shutter assembly 36 now opens, in the manner described above. Repulsive force exerted by magnet 34 causes central magnet 22 again to reverse direction, returning toward the left end of the path. This sort of oscillatory motion continues for some time, thus driving shaft 26 and causing generator 30 to output electrical power continuously.

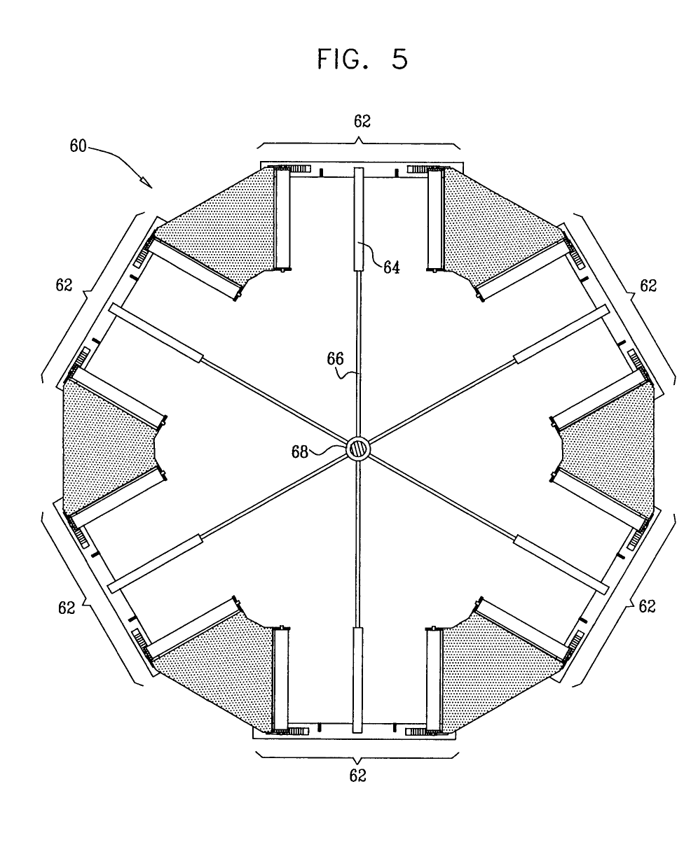

FIG. 5 is a schematic, frontal view of a system 60 for magnetic power generation, in accordance with another embodiment of the present invention. The system comprises multiple machines 62, which operate on principles similar to those of machine 20, as described above. Each machine 62 comprises a central magnet 64, which is connected by a linkage 66, together with the central magnets of the other machines, to drive a shaft 68. This collective drive arrangement intensifies the power that can be supplied to the shaft. Other drive configurations, using a single machine or multiple, linked machines, will be apparent to those skilled in the art and are considered to be within the scope of the present invention.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A magnetic power generating machine, comprising:
a central magnet, which is configured to traverse a path having first and second ends, and is connected by a linkage to rotate a shaft as the central magnet traverses the path;
first and second side magnets, which are respectively disposed adjacent to the first and second ends of the path and are oriented to repel the central magnet, so that a magnetic force between the central magnet and the first and second side magnets causes the central magnet to oscillate between the first and second ends of the path, thereby rotating the shaft; and
first and second shutter assemblies, respectively disposed between the first and second side magnets and the first and second ends of the path, the first and second shutter assemblies being operative to move toward the central magnet, due to a magnetic attraction, as the central magnet approaches the shutter assembly, each of said first and second shutter assemblies comprising:
at least one ferromagnetic shutter, having open and closed positions; and
a mechanism, which is arranged to open the at least one ferromagnetic shutter as the central magnet approaches the shutter assembly, thereby modulating the magnetic force synchronously with oscillation of the central magnet.

2. The machine according to claim 1, wherein the shaft is coupled to generate electrical power as it rotates.

3. The machine according to claim 1, wherein the mechanism is arranged to open the at least one ferromagnetic shutter as a result of movement of a shutter assembly toward the central magnet.

4. The machine according to claim 3, wherein the mechanism comprises at least one gear, which is coupled to turn the at least one shutter, and is configured so that the movement of the shutter assembly toward the central magnet causes the at least one gear to turn.

5. A magnetic power generating system comprising a plurality of magnetic power generating machines according to claim 1, wherein the machines are collectively linked to rotate the shaft.

6. A method of magnetic power generation, comprising:
coupling a central magnet to rotate a shaft as the central magnet traverses a path having first and second ends;
positioning first and second side magnets adjacent to the first and second ends of the path and orienting the first and second side magnets to repel the central magnet, so that a magnetic force between the central magnet and the first and second side magnets causes the central magnet to oscillate between the first and second ends of the path, thereby rotating the shaft; and
disposing first and second shutter assemblies respectively between the first and second side magnets and the first and second ends of the path, the first and second shutter assemblies being operative to move toward the central magnet, due to a magnetic attraction, as the central magnet approaches the shutter assembly, each of said first and second shutter assemblies comprising:
at least one ferromagnetic shutter, having open and closed positions; and
a mechanism, which is arranged to open the at least one ferromagnetic shutter as the central magnet approaches the shutter assembly, thereby modulating the magnetic force synchronously with oscillation of the central magnet.

7. The method according to claim 6, and comprising coupling the shaft to generate electrical power as it rotates.

8. The method according to claim 6, wherein the mechanism is arranged to open the at least one ferromagnetic shutter as a result of movement of a shutter assembly toward the central magnet.

9. The machine according to claim 8, wherein the mechanism comprises at least one gear, which is coupled to turn the at least one shutter, and is configured so that the movement of the shutter assembly toward the central magnet causes the at least one gear to turn.
